(19) United States
(12) Patent Application Publication
(10) Pub. No.: US 2011/0121513 A1
(43) Pub. Date: May 26, 2011

(54) SEALING RING AND DEVICE AND METHOD FOR INSTALLING A SEALING RING

(76) Inventor: Gerhard Lechler, Berlin (DE)

(21) Appl. No.: 12/737,246

(22) PCT Filed: May 25, 2009
(86) PCT No.: PCT/EP2009/003678

§ 371 Date: Feb. 1, 2011

(30) Foreign Application Priority Data
Jun. 27, 2008 (DE) 10 2008 030 174.4

(51) Int. Cl. F16J 15/16; B23P 19/08

(52) U.S. Cl. 277/300; 29/240; 277/500

(57) ABSTRACT

(EN) The invention relates to an installation device (3) for installing a sealing ring (1) on or in a component (2), for example a shaft or a housing, comprising a coupling member (4) for transmitting an installation force (F) to the sealing ring (1). The invention further relates to a sealing ring (1) comprising a rubber elastic base body (11) and a reinforcing ring (12), wherein the reinforcing ring (12) is embedded at least sectionally into the rubber elastic base body (11). The invention further relates to a method for installing a sealing ring (1) on or in a component (2), wherein the sealing ring (1) is inserted onto or into the component (2) in the axial direction. In order to improve the installation of sealing rings (1) of the type mentioned above such that a centric and right-angle position of the sealing ring (1) is ensured after removal of the installation force, a rotational drive (8), by which a relative movement between the sealing ring (1) and component (2) can be produced, is provided for the installation device (3). The sealing ring (1) is rotated relative to the component during installation and for this purpose has at least one stop surface (23, 32, 32′) facing substantially in the circumferential direction (U).

The invention relates to an installation device for installing a sealing ring on or in a component, for example a shaft or a housing, comprising a coupling member for transmitting an installation force to the sealing ring. The invention further relates to a sealing ring comprising a rubber elastic base body and a reinforcing ring, wherein the reinforcing ring is embedded at least sectionally into the rubber elastic base body, as well as a method for installing a sealing ring on or in a component, wherein the sealing ring is slid onto or into the component in the axial direction.

Rotating or swivelling machine elements are lubricated for a long service life. Sealing rings are normally built in in order to keep the lubricating medium in the area of the lubricating points and to rule out contamination of the lubricating medium or the surroundings.

Particularly shaft sealing rings that are used as rotation seals often are made from a rubber elastic base body which is reinforced by a reinforcing ring that is made of a stiffer material such as metal. Shaft sealing rings conventionally have a rubber elastic sealing lip that lies on the component that is to be sealed, for example, a shaft or axle, on the interior side of the sealing ring. A tension spring that produces an initial tension that operates inwards in the radial direction can be integrated into the sealing lip.

Shaft sealing rings are normally slid onto a shaft or into a bore hole in an axial direction, whereby a tool exerts an axial force on the circumference of the sealing ring in the installation direction. In order for the sealing ring to be arranged in a position that is centric and at a right angle with respect to the shaft and/or bore hole, the installation force that is normally exerted on the sealing ring in the axial direction during installation should lie on the symmetry line of the sealing ring. In order to avoid deformation of or damage to the sealing ring when it is being pressed in, the installation force should be applied as close as possible to the outer diameter.

U.S. Pat. No. 6,065,198, U.S. Pat. No. 7,131,197 B1 and U.S. Pat. No. 5,709,018 show installation devices for shaft sealing rings in which the installation force is transmitted to an axially running coupling member via a threaded bar or screw arranged concentrically to the shaft sealing ring, whereby the coupling member acts on the sealing ring.

U.S. Pat. No. 3,030,702 describes an installation plate for holding the shaft sealing ring that is connected via a threaded bar to an adjustable stop for adjusting the axial installation position of the sealing ring. Upon reaching a predetermined axial position of the shaft sealing ring in the assigned bore hole, the stop lies against the entrance of the bore hole.

Each of the devices of U.S. Pat. No. 4,515,376, U.S. Pat. No. 3,165,949, DE 262 807 and U.S. Pat. No. 4,550,486 has two cylindrical elements that lie one within the other and that can be slid one into the other. The sealing ring is slid on to the inner cylindrical element before the installation. The sealing ring can be arranged centrically by positioning the device coaxially on the bore hole for holding the sealing ring. An installation force is exerted on the circumference of the sealing ring by means of axially displacing the outer cylindrical element.

U.S. Pat. No. 5,052,695, DE 2340275 B, DE 3503602 C1 and EP 0794037 B1 show installation rings for shaft sealing rings. The installation ring of U.S. Pat. No. 5,052,695 and DE 2340275 B is inserted into the shaft sealing ring via a sleeve-shaped extension on which the sealing lip of the shaft sealing ring lies. The installation ring of DE 3503602 C1, on the other hand, is latched with the inner circumference of the sleeve-shaped sheath part of the shaft sealing ring. The installation ring of EP 0794037 B1 is said to be particularly suitable for installing shaft sealing rings with raceways for the sealing lips.

The air side or bottom side of the shaft sealing ring lies on a support surface of the tool, by means of which an axial installation force is transmitted to the shaft sealing ring. In order to prevent the shaft sealing ring from releasing from the installation ring, the shaft sealing ring can, in accordance with U.S. Pat. No. 5,052,695 be held to the installation ring by means of an adhesive or by elastic extensions.

U.S. Pat. No. 6,370,751 B1 deals with an installation aid for shaft sealing rings that substantially consists of a conically formed metal cap. While the edge of the metal cap lies on the sealing ring, the installation force can be transmitted to the shaft sealing ring by means of a wooden piece centrically arranged on the metal cap.

U.S. Pat. No. 5,709,018 deals with a removal tool for removing shaft sealing rings with a gripper that engages in the pressure side of the shaft sealing ring. The gripper is substantially tubular in shape and has slots running along the length on its side facing the sealing ring. A conical bore hole in the gripper lies on a conical flange connected to the threaded bar. By being slid via a threaded nut in the direction of the conical flange, the gripper widens and grips into the pressure side of the shaft sealing ring in a frictional, positive-locking connection.

For reliable sealing of the component, the sealing ring must also be arranged centrically and at a right angle to the component after the installation process. While being pressed in, the sealing ring deforms under the influence of the installation force due to its geometry and the low rigidity of the sealing materials. In this way, for example, when a shaft sealing ring is being slid into a bore hole, at the end of the sliding movement an elastic deformation of the sealing ring can remain that stays in place due to the static friction between the sealing ring and bore hole. This elastic deformation leads to resilience after the installation force is removed and consequently to a movement or to a tilting of the sealing ring. Such movements lead to the sealing ring being no longer centrically arranged at a right angle to the component and consequently the sealing surfaces no longer lie uniformly on the machine elements to be sealed, i.e., a reliable sealing effect is no longer guaranteed.

The basis of the present invention is therefore to improve the assembly of sealing rings of the abovementioned kind in such a way that a centric and right-angle position of the sealing ring is guaranteed after the installation force is removed.

The invention solves the object for the installation device mentioned at the beginning by providing a rotational drive by means of which a relative rotation can be produced between the sealing ring and component.

The installation device according to the invention can be enhanced by various, mutually independent developments, each of which is advantageous in itself. The following is a brief discussion of these developments and the advantages associated with each of the developments.

In order to allow a positive-locking connection between the sealing ring and the installation device, the coupling member can comprise at least one positive-locking element. This positive-locking element can be developed as an extension that engages in a corresponding recess in the sealing ring. Alternatively or additionally, the coupling member can have a positive-locking element that is developed as a recess and that receives corresponding assigned extensions of the sealing ring.

The positive-locking element developed as an extension or recess allows a positive-locking transmission of the peripheral force that is transmitted by the rotational drive and that acts in the circumferential direction of the sealing ring. In this way, significantly larger peripheral forces or moments of force that act around the symmetry axis of the sealing ring can be transmitted than with a purely frictionally-engaged connection between the coupling member and sealing ring. The positive-locking element additionally allows an attachment of the sealing ring to the coupling member of the installation device before this is installed on or in a component. In this way, the sealing ring can be arranged at a right angle and centred with respect to the component with the help of the installation device so that tilting of the sealing ring during the installation is avoided.

In order to align the sealing ring in a centric and right-angle manner with respect to the component, the installation device can have centring extensions that are inserted into a central bore hole of the component during the installation. The extension can be developed as a part of a cylindrical section of the installation device in the form of a turned-down portion that is inserted, for example, into the retainer bore hole for the sealing ring during installation. The installation device can alternatively be given a central bore hole for holding a centring extension or a turned-down portion of the component.

The positive-locking element can have undercuts with at least one surface running substantially diagonally to the axial direction or to the installation direction. The surface running diagonally to the axial direction can, if paired with a complementarily developed undercut of the sealing ring, lie on a surface of the sealing ring running diagonally to the axial direction. With the introduction into the sealing ring of a peripheral force by the installation device, a force acting in the axial direction arises due to the surface pairings running diagonally to the axial direction. If the diagonal surfaces of the undercuts slide into one another with a relative rotation of the coupling member with respect to the sealing ring, the sealing ring is pulled on to the coupling member. The sealing ring is pressed on to the coupling member in the axial direction and, in addition to the positive-locking connection, there arises a frictionally-engaged connection between the sealing ring and the coupling member.

The positive-locking elements can be developed as notches so that a snapping of the positive-locking element into place in a corresponding recess or a corresponding extension of the sealing ring is possible. As a result of this measure, a positive-locking connection can be brought about between the coupling member and the sealing ring that allows a transmission of forces in the circumferential direction of the sealing ring as well as in the axial direction in and against the installation direction.

According to a further advantageous development, the coupling member can have at least one stop surface facing substantially in the circumferential direction. This stop surface can be an integral constituent of a positive-locking element or can be arranged on the coupling member in a manner separate to the positive-locking elements. The stop surface should point in the rotation direction preferred during installation, so that this can transmit the rotational force generated by the rotational drive onto the sealing ring when hitting a correspondingly developed counter-surface of the sealing ring.

The stop surface can furthermore have at least one undercut so that when the coupling member is rotated by the rotational drive, the stop surface generates a force on a corresponding counter-surface of the sealing ring that runs parallel to the stop surface and borders the stop surface, by means of which the coupling member and sealing ring are pressed on to each other.

According to a further advantageous development, the coupling member can have a low pressure chamber developed to be closed on at least one side by the sealing ring and connected to a low pressure line. By closing the low pressure chamber with the sealing ring and generating a low pressure in the low pressure chamber by means of the low pressure line, there results a suction force that pulls the sealing ring on to the coupling member. The surfaces of the coupling member surrounding the low pressure chamber that border the sealing ring are pressed on to the sealing ring by the suction force and, in this way, form a frictionally-engaged connection with the bordering surfaces of the sealing ring, whereby this connection allows a non-slip transmission of the peripheral forces caused by the rotational drive to the sealing ring.

The low pressure chamber can border the surface of the air side of the shaft sealing ring that faces in the axial direction for the installation of conventional shaft sealing rings. If there is space available during the installation, the low pressure chamber can also border on a surface of the face side of the shaft sealing ring that faces in the axial direction or it can be closed by the support surface of the shaft sealing ring facing outwards in the radial direction.

This object is solved for the sealing ring mentioned at the beginning in that the sealing ring has at least one stop surface pointing substantially in the circumferential direction.

The solution according to the invention can be combined in any way and further improved with the following further development forms, each of which is advantageous in itself.

The stop surface of the sealing ring can also have at least one undercut in accordance with the stop surface of the abovementioned installation device. In this way a positive locking acting in the axial direction is possible between the stop surface of the sealing ring and a correspondingly developed stop surface of the installation device. If the undercut forms a flat surface running substantially diagonally to the axial direction or installation direction, the pairing with a correspondingly developed counter-surface of the installation device causes the sealing ring to be pulled to the installation device with the introduction of a rotational force by the installation device, and there results a frictionally-engaged connection between the sealing ring and installation device.

The sealing ring can be given at least one positive-locking element corresponding to the installation device on an installation contact surface accessible from the outside. The positive-locking element can be developed as an extension that can be inserted into a corresponding recess of the installation device, or as a recess that holds a corresponding extension of the installation device. A positive-locking element of this kind allows the attachment of the sealing ring to the installation device so that the sealing ring can be connected to the installation device even before its installation. In this way, even difficult to access components can be reached with the help of the installation device in order to install the sealing ring. Furthermore, an installation device provided with a centring device can be used for positioning the sealing ring at a right angle and centric to the sealing ring holder before this is slid into or onto the component.

In a further advantageous development of the sealing ring according to the invention, this sealing ring can have a coupling member that is glued to the sealing ring. The glued connection between the sealing ring and coupling member can have a strength that allows the transmission of the installation force, but that lies below a predetermined value that, if exceeded, causes the coupling member to be disconnected from the sealing ring when a force is introduced via the installation device. For example, the surface of the air or bottom side of the sealing ring that faces in the axial direction can be glued to the coupling member, because with conventional shaft sealing rings, this is large enough in order to form suitable, high-strength glued connections for the installation of the sealing ring. In order to centre the sealing ring with respect to the coupling member, the coupling member can have turned-down portions on to which the sealing ring is slid at least sectionally.

For the method mentioned at the beginning, the object is solved according to the invention in that not only is the sealing ring slid onto or into the component for its installation, it is additionally rotated relative to the component.

As a result of the rotation, the sealing ring is primarily deformed in the circumferential direction and no longer in the axial direction. The deformations in the circumferential direction are, however, harmless for the exact axial positioning of the sealing ring. The positioning accuracy is consequently significantly improved.

The sealing ring can be rotated while it is being slid into or onto the component. By overlapping the sliding and rotational movement, the installation method is shortened overall.

In order to reduce the wear of the sealing ring or the sealing ring holder during the installation, the rotation of the sealing ring can be limited to a section of the installation movement that lies shortly before reaching the end position of the sealing ring. In this way, the relative movement between the sealing ring and component and consequently the heating created by the friction are restricted. Alternatively, the sealing ring can first be slid into or onto the component and not rotated until after it has reached its axial end position. In this way, possibly increased wear of the sealing ring that is caused by the overlapping of the sliding and the rotational movement is completely avoided.

In the following, the invention is explained by way of example, using different embodiments and with reference to the figures. The described embodiments here depict only actual developments that can be modified for the respective application. Individual features that are advantageous in themselves can be added or left out for the particular described embodiment according to the above description of the advantageous developments.

Shown are:

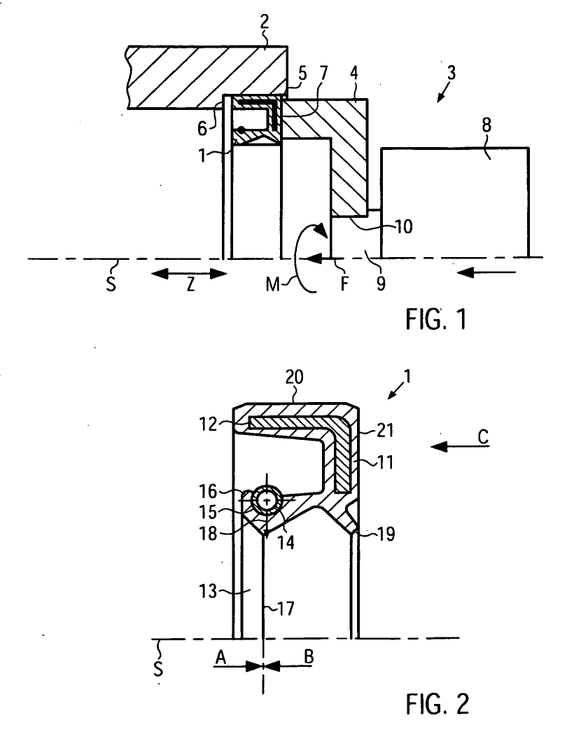

FIG. 1 a schematic sectional representation of a first embodiment of the invention;

FIG. 2 a schematic sectional representation of a shaft sealing ring from the state of the art;

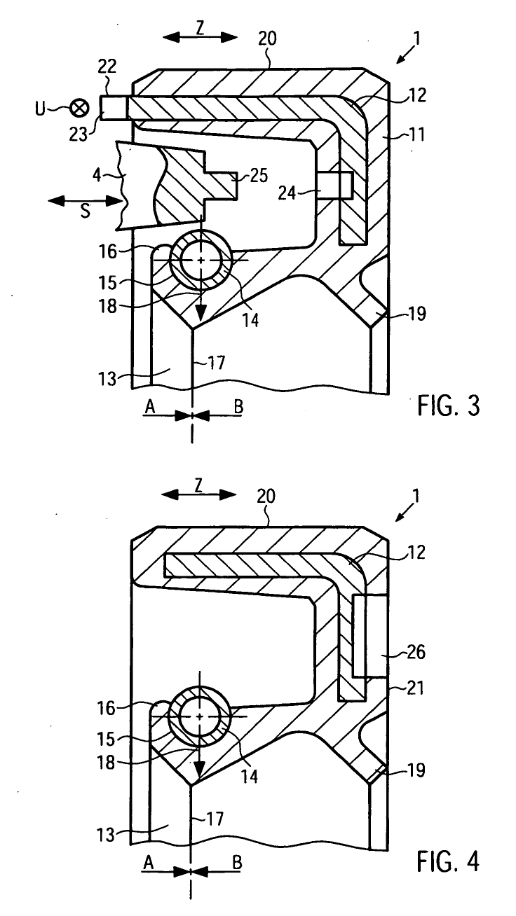

FIG. 3 a schematic sectional representation of a first embodiment of the sealing ring according to the invention;

FIG. 4 a schematic sectional representation of a second embodiment of the sealing ring according to the invention;

FIG. 5 a schematic sectional representation of a conventional shaft sealing ring with a detail of an embodiment of the installation device according to the invention;

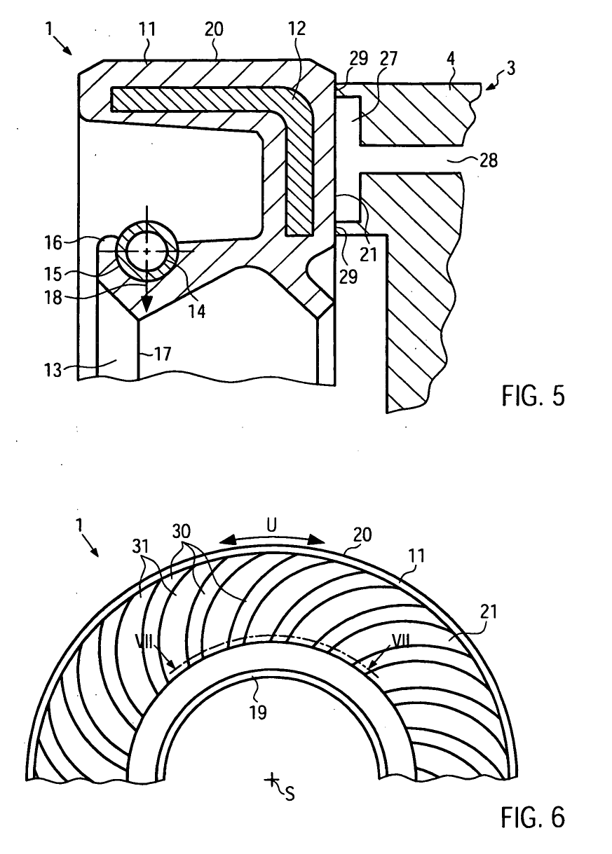

FIG. 6 a schematic side view of a third embodiment of the sealing ring according to the invention;

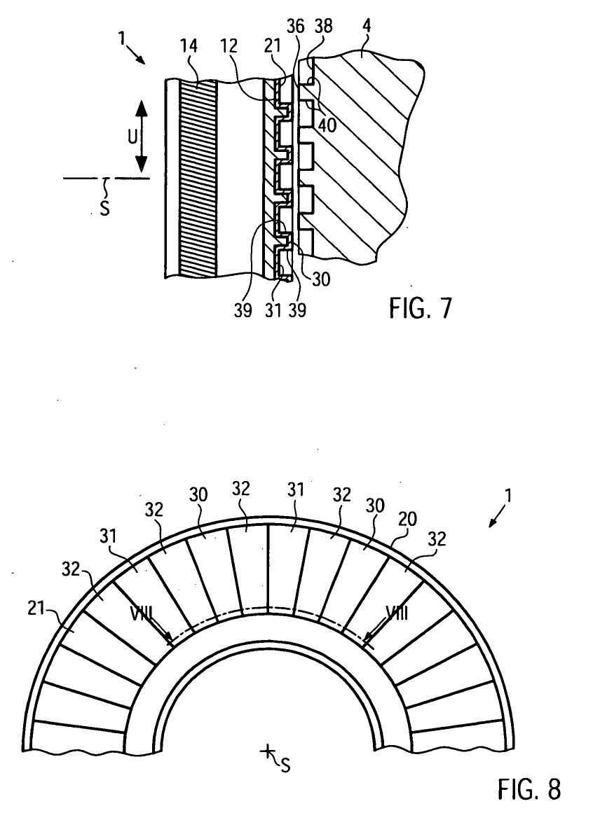

FIG. 7 a schematic sectional representation of a detail of the third embodiment of the sealing ring according to the invention at the point VII-VII of FIG. 6, as well as of a third embodiment of the installation device.

FIG. 8 a schematic side view of a fourth embodiment of the sealing ring according to the invention;

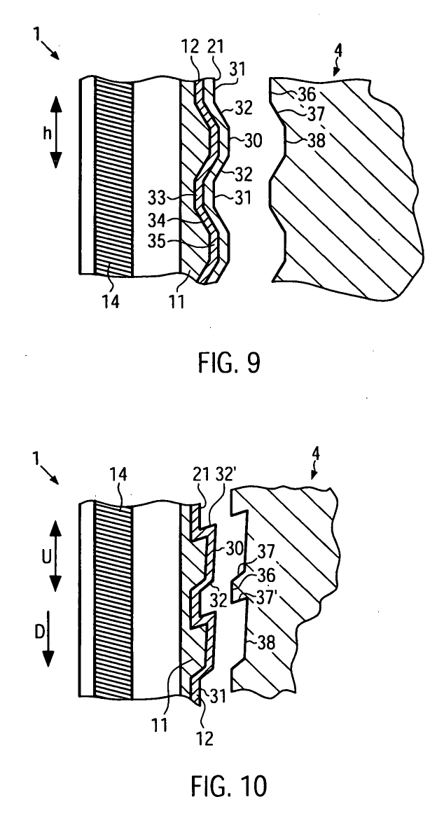

FIG. 9 a schematic sectional representation of a detail of the fourth embodiment of the sealing ring according to the invention at the point VIII-VIII of FIG. 7, as well as of a second embodiment of the installation device;

FIG. 10 a schematic sectional representation of a detail of a fifth embodiment of the sealing ring according to the invention.

FIG. 1 shows a sealing ring 1 that is inserted into a component 2. The sealing ring 1 borders an installation device 3 that exerts an installation force F on the sealing ring 1 via a coupling member 4. The sealing ring 1, the component 2 and the installation device 3 are constructed in such a way that they are symmetric to a symmetry axis S, whereby in each case, only the half that lies above the symmetry axis S is shown.

The installation force F that faces in an installation direction Z or in the axial direction lies on the plane of symmetry S and is transmitted from the installation device 3 to the sealing ring 1 via the coupling member 4. The sealing ring is slid into the component 2 in this way in the installation direction Z and in the direction of the symmetry axis S, whereby the component 2 has a bore hole 5 for holding the sealing ring 1. The component 2 is provided with a turned-down portion 6 at the end of the bore hole 5, whereby this turned-down portion 6 defines the end of the bore hole 5 and consequently the end position of the sealing ring 1.

While the sealing ring 1 is being slid into the bore hole 5 or after the sealing ring 1 has reached the end position at the turned-down portion 6, a moment of force M is introduced into the coupling member 4 via the installation device 3 that is transmitted to the sealing ring 1 via an installation contact surface 7. The moment of force M acts around the symmetry axis of the sealing ring S. To transmit the moment M or the transverse forces resulting from the moment M to the sealing ring 1, the installation contact surface 7 has positive-locking or frictional-connection elements, not shown here, that are explained in the following figures in various embodiments by way of example.

To produce the moment of force M, the installation device 3 has a rotational drive 8 that produces a moment M that is large enough to overcome the static friction between the sealing ring 1 and the surfaces of the component 2 bordering the sealing ring 1. While the sealing ring 1 initially borders only the inner surface of the bore hole 5, in the final installation position it strikes the surface of the turned-down portion 6 that faces the sealing ring 1. The rotational drive 8 can also overcome the increased static friction with this additional contact surface.

The moment of force M of the rotational drive 8 reaches into the coupling member 4 via a shaft 9 and a shaft-hub connection 10. The shaft-hub connection 10 can be executed as a frictionally-engaged shaft-hub connection 10, for example, a press-fit connection, as a positive-locking shaft-hub connection 10, for example a spline shaft or toothed shaft connection, or as an integral connection 10.

FIG. 2 shows a radial shaft sealing ring 1 known from the state of the art. The sealing ring 1 comprises a rubber elastic base body 11 that encloses a reinforcing ring 12. The sealing ring 1 is provided with a sealing lip 13, which is held under tension by a tension spring 14 that encloses the circumference of the sealing lip 13. The tension spring 14 is arranged in a spring groove 15 that is bordered by a spring holding collar 16 on the face side of the shaft sealing ring 1. The sealing lip 13 has a sealing edge 17 below the spring groove 15. The tension spring 14, which has an initial tension, produces a spring force that presses on the circumference of the sealing lip 13 in the direction of the spring's line of application 18. In this way, the sealing edge 17 is held on the component enclosed by the sealing ring 1.

On the bottom side B, the sealing ring 1 is provided with a dust lip 19, which protects the space located on the face side A and sealed off from the bottom side B against contaminations due to penetrating dirt.

The sealing ring 1 is surrounded on its outer circumference by an outer sheath 20 that is formed by a section of the rubber elastic base body 11. A bottom surface 21 located on the bottom side B or air side B of the sealing ring 1 is likewise formed from the rubber elastic base body 11.

FIG. 3 shows a first embodiment of the sealing ring according to the invention, whereby the same reference numbers are used for elements that correspond in function and construction to the elements of the sealing ring from the state of the art shown in FIG. 2.

The reinforcing ring 12 protrudes from the rubber elastic base body 11 on the face side A of the sealing ring 1. It has a recess 22 that comprises a stop surface 23 which runs parallel to the axis direction S or the installation direction Z, but perpendicular to the circumferential direction U. The recess 22 serves to hold a correspondingly developed extension of the coupling member 4, so that installation forces acting in the circumferential direction U can be transmitted from the coupling member 4 to the sealing ring 1.

The reinforcing ring 12 can have a multiplicity of recesses 22 that are distributed across the circumference of the reinforcing ring 12 in constant angular distances in order to avoid a lateral relocation of the sealing ring 1 during the installation process caused by peripheral forces. The recess 22 can be undercut, so that the stop surface 23 runs diagonally to the circumferential direction U. If the coupling member of the installation device also has corresponding extensions with diagonal contact surfaces, there results from a rotational force transmitted in the circumferential direction U to the sealing ring 1 a force acting in the installation direction Z that pulls the sealing ring 1 in the direction of the coupling member 4 arranged on the face side A or that presses it away from the coupling member 4.

Provided on the interior side of the sealing ring is a positive-locking element 24 that serves to hold a complementary positive-locking element 25 provided on the coupling member 4. Peripheral forces or moments of force can also be transmitted to the sealing ring 1 via the positive-locking elements 24 and 25 during the installation. In addition, the positive-locking elements 24, 25 allow an attachment of the sealing ring to the coupling member 4 of the installation device 3, so that the position of the sealing ring 1 is defined in relation to the installation device 3 even before the installation begins. The installation device 3 can have at least one centring element for centring the coupling member 4 with respect to the component, so that the position of the sealing ring 1 is unambiguously defined with respect to the component by the attachment to the installation device 3 even before the installation process. The centring element can be developed, for example, as an extension that is inserted into the recesses of the component or as a recess that holds an extension of the component.

FIG. 4 shows a further embodiment of the sealing ring according to the invention, whereby the same reference numbers are used for elements that correspond in function and construction to the elements of the embodiment of FIG. 3. For the sake of brevity, the differences to the embodiment of FIG. 3 are gone into.

The sealing ring 1 is provided with a positive-locking element 26 in the form of a recess 26 on its bottom side B. The recess 26 cuts both the rubber elastic base body 11 and the reinforcing ring 12. In contrast to the embodiment of FIG. 3, the coupling member 4 of the installation device 3 in the embodiment of FIG. 4 can engage in the positive-locking element 26 from the bottom side B of the sealing ring 1. Because the recess 26 also cuts the reinforcing ring 12, relatively large peripheral forces can be transmitted to the sealing ring 1, which makes it possible to overcome the static friction between the outer sheath 20 of the sealing ring 1 and the component when the sealing ring is installed.

FIG. 5 shows a section view of a conventional shaft sealing ring with a detail of an embodiment of an installation device 3 according to the invention. The coupling member 4 of the installation device 3 lies on the bottom surface 21 of the sealing ring 1. The coupling member 4 has a low pressure chamber 27 into which a low pressure line 28 leads. Via a suction pump, not shown here, that is connected to the low pressure line 28, the medium located in the low pressure chamber 27 can be transported in the direction of the suction pump so that a low pressure arises in the low pressure chamber 27 that pulls the sealing ring bordering the low pressure chamber 27 to the coupling member 4. At the same time, the supporting surfaces 29 of the coupling member 4 that border the bottom surface 21 of the sealing ring 1 seal the low pressure chamber 27 off from the surroundings. The contact pressure produced between the supporting surface 29 and the bottom surface 21 that corresponds to the low pressure in the low pressure chamber 27 ensures a positive-locking connection between the coupling member 4 and sealing ring 1, by means of which peripheral forces or moments of force can be transmitted from the installation device 3 to the sealing ring 1.

FIG. 6 shows a third embodiment of the sealing ring 1 according to the invention, whereby the same reference numbers are used for elements that correspond in function and construction to the elements of the embodiments of FIGS. 3 and 4. For the sake of brevity, the differences to the embodiments of FIGS. 3 and 4 are gone into.

Arranged on the bottom surface 21 of the sealing ring 1 are curved extensions 30 that spread out in the direction of the outer sheath 20. Due to the curved profile of the extensions 30, the surface load on the flanks of the extensions 30 is reduced.

FIG. 7 shows a detail of the third embodiment of the shaft sealing ring according to the invention at the point VII-VII of FIG. 6. The bottom surface 21 is formed from the reinforcing ring 12, which has extensions 30 and indentations 31 with a substantially rectangular profile. Extensions 36 of a correspondingly formed coupling member 4 engage in the indentations 31 of the reinforcing ring 12, while indentations 38 in the coupling member 4 hold the extensions 30 formed from the reinforcing ring 12.

If the coupling member 4 is placed on to the bottom surface 21 centric to the symmetry line S of the sealing ring 1, the recesses 38 on the coupling member 4 enclose the extensions 30 and, in this way, transmit the peripheral force applied by the rotational drive of the installation device.

On the basis of the curved course of the extensions 30, 36, shown in FIG. 6, and the indentations 31, 38, a twisting of the coupling member 4 in the circumferential direction U leads to a displacement of the side surfaces 39 of the extensions 30 of the reinforcing ring 12 with respect to the side surfaces 40 of the extensions 36 of the coupling member 4. In this way, there results a surface pressure between the side surfaces 39 and 40 that results in a positive-locking connection between the sealing ring 1 and the coupling member 4.

The pitch of the profile lines of the extensions 30 that is variable across the diameter of the sealing ring 1 allows a wedge effect between the extensions 30 and the corresponding indentations 38 of the coupling member, which fixes in place the positive-locking connection between the sealing ring 1 and the coupling member 4. Due to the fact that the coupling member is twisted around the symmetry axis S with respect to the sealing ring 1 after being placed on the bottom surface 21, the side surfaces 39, 40 move toward each other. Due to the fact that the extensions 30, 36 deform elastically with this movement, there results an initial tension between the side surfaces 39, 40 which increases the static friction between the side surfaces 39, 40. The curved side surfaces 39 of the extensions 30 consequently become wedged together with the side surfaces 40 of the corresponding indentations 38 of the coupling member.

FIG. 8 shows a fourth embodiment of the sealing ring according to the invention in a schematic side view. For the sake of brevity, only the differences to the embodiments of FIGS. 3, 4, 6, and 7 are gone into, whereby the same reference numbers are used for elements that correspond in function and construction to the elements of the first embodiment.

The bottom surface 21 of the sealing ring 1 has extensions 30 and indentations 31 that are connected to one another via bevels 32. Each of the extensions 30, indentations 31 as well as the bevels 32 extends perpendicularly to the circumference of the sealing ring 1, whereby they spread out away from the centre marked by the symmetry line S.

FIG. 9 shows a section view of the fourth embodiment of the sealing ring 1 at the point VIII-VIII of FIG. 8, as well as a section view of a detail of the coupling member 4 of an additional explanatory embodiment of the installation device.

The geometry of the bottom surface 21 is determined by the reinforcing ring 12 that has indentations 33, bevels 34 and extensions 35 corresponding to the bottom surface 21. The indentations 33, bevels 34 and extensions 35 additionally reinforce the reinforcing ring 12. The reinforcing ring 12 is enveloped by the rubber elastic base body 11 so that the bottom surface 21 is formed by the rubber elastic base body and is supported by the reinforcing ring 12 lying below it. Corresponding to the sealing ring 1, the complementarily formed coupling member 4 also has extensions 36, bevels 37 and indentations 38.

For the installation of the sealing ring 1, the coupling member 4 is placed on to the bottom surface 21 so that the indentations 38 of the coupling member 4 hold extensions 30 of the bottom surface 21 while indentations 31 of the bottom surface 21 hold extensions 36 of the coupling member. In this way, there results a positive locking that allows the positive-locking transmission of forces in the circumferential direction U.

FIG. 10 shows a fifth embodiment of the sealing ring according to the invention, whereby the same reference numbers are used for elements that correspond in function and construction to the elements of the embodiments of FIGS. 3, 4, 6, 7 and 8. For the sake of brevity, the differences to the previous embodiments are gone into.

The bottom surface 21 of the sealing ring 1 has extensions 30, bevels 32, 32′ as well as indentations 31. In contrast to the embodiment of FIG. 9, the reinforcing ring 12 is not enveloped on its outer side by the rubber elastic base body 11 and consequently forms the bottom surface 21. Due to the harder surface of the reinforcing ring 12, which is preferably manufactured of metal, larger surface loads can be introduced during the installation via the engaging coupling member 4 and consequently larger peripheral forces can be introduced.

The reinforcing ring 12 has undercuts that are formed by the bevels 32′. During the installation, the extensions 36 of the coupling member 4 engage in the undercuts formed by the bevels 32′. When the coupling member 4 is rotated in a rotation direction D, the bevels 37′ of the coupling member 4 lie on the bevels 32′ of the reinforcing ring 12. Because the bevels 32′ and 37′ formed as undercuts run diagonally to the rotation direction D, the introduction of a peripheral force acting in the rotation direction D via the coupling member 4 leads to the extensions 30 gliding into the recesses 38 or the extensions 36 gliding into the recesses 31. Due to the undercuts 32′ and 37′, when a peripheral force is introduced there consequently arises a force component that presses the coupling member 4 and the sealing ring 1 on to each other and consequently also allows the transmission of an axial tensile force from the coupling member 4 on to the sealing ring 1. As a result, the shown embodiment of the sealing ring 1 with the corresponding embodiment of the coupling member 4 is suitable for both the assembly and the non-destructive removal of a shaft sealing ring 1.

The profiles, shown in FIG. 7, 8, 9, of the bottom surface 21 offer not only the possibility of a positive-locking connection to the coupling member 4, but also lead to a reinforcement of the reinforcing ring 12, as a result of which the sheet thickness of the reinforcing ring 12 and consequently the material costs for manufacturing a sealing ring 1 can be reduced. According to the embodiments known from the state of the art, the sealing rings according to the invention can also be developed with two or more tension-spring-loaded sealing lips, also without tension spring or without dust lip. Alternatively to the inner or outer side of the sealing ring, the reinforcing ring can border the rubber elastic base body. On the face side of the sealing ring, an additional reinforcing ring in the form of a cap can be provided.

The features of the embodiments of installation devices and sealing rings described above can also be transferred to other forms of sealing rings, for example, axial shaft sealing rings or rod seals.

1. Installation device (3) for installing a sealing ring (1) on or in a component (2), for example a shaft or a housing, comprising a coupling member (4) for transmitting an installation force (F) to the sealing ring (1), characterised in that a rotational drive (8) is provided by means of which a relative rotation can be produced between the sealing ring (1) and component (2).

2. Installation device (3) according to claim 1, characterised in that the coupling member (4) comprises at least one positive-locking element (25, 36, 38).

3. Installation device (3) according to claim 1, characterised in that the coupling member (4) has at least one stop surface (37, 37′, 40) substantially facing in the circumferential direction (U).

4. Installation device (3) according to claim 3, characterised in that the stop surface (37, 37′, 40) has at least one undercut (37′).

5. Installation device (3) according to claim 1, characterised in the coupling member (4) has at least one low pressure chamber (27) that is developed so that it can be closed on at least one side of the sealing ring (1) and that is connected to a low pressure line (28).

6. Sealing ring (1) that comprises a rubber elastic base body (11) and a reinforcing ring (12), wherein the reinforcing ring (12) is embedded at least sectionally into the rubber elastic base body (11), characterised in that the sealing ring (1) has at least one stop surface (23, 32, 32′) facing substantially in the circumferential direction (U).

7. Sealing ring (1) according to claim 6, characterised in that the stop surface (23, 32, 32′) has at least one undercut (32′).

8. Sealing ring (1) according to claim 6, characterised in that the sealing ring (1) is provided with at least one positive-locking element (24, 26).

9. Sealing ring (1) according to claim 6, characterised in that the sealing ring (1) has a coupling member that is glued to the sealing ring (1).

10. Method for installing a sealing ring (1) on or in a component (2), wherein the sealing ring (1) is inserted onto or into the component (2) in the axial direction, characterised in that the sealing ring (1) is additionally rotated relative to the component (2).

11. Method according to claim 10, characterised in that the sealing ring (1) is simultaneously slid and rotated.

12. Method according to claim 10, characterised in that the sealing ring (1) is first slid and then subsequently rotated.

13. Installation device (3) according to claim 2, characterised in that the coupling member (4) has at least one stop surface (37, 37′, 40) substantially facing in the circumferential direction (U).

14. Installation device (3) according to claim 2, characterised in the coupling member (4) has at least one low pressure chamber (27) that is developed so that it can be closed on at least one side of the sealing ring (1) and that is connected to a low pressure line (28).

15. Installation device (3) according to claim 3, characterised in the coupling member (4) has at least one low pressure chamber (27) that is developed so that it can be closed on at least one side of the sealing ring (1) and that is connected to a low pressure line (28).

16. Installation device (3) according to claim 4, characterised in the coupling member (4) has at least one low pressure chamber (27) that is developed so that it can be closed on at least one side of the sealing ring (1) and that is connected to a low pressure line (28).

17. Sealing ring (1) according to claim 7, characterised in that the sealing ring (1) is provided with at least one positive-locking element (24, 26).

18. Sealing ring (1) according to claim 7, characterised in that the sealing ring (1) has a coupling member that is glued to the sealing ring (1).

19. Sealing ring (1) according to claim 8, characterised in that the sealing ring (1) has a coupling member that is glued to the sealing ring (1).

20. Installation device (3) according to claim 13, characterised in the coupling member (4) has at least one low pressure chamber (27) that is developed so that it can be closed on at least one side of the sealing ring (1) and that is connected to a low pressure line (28).
